(19) United States
(12) Patent Application Publication
(10) Pub. No.: US 2007/0091930 A1
(43) Pub. Date: Apr. 26, 2007

(54) Dual transmission stream processing device and method

(75) Inventors: Jung-pil Yu, Suwon-si (KR); Eui-jun Park, Seoul (KR); Yong-sik Kwon, Seoul (KR); Yong-deok Chang, Suwon-si (JP); Hae-joo Jeong, Seoul (KR); Joon-soo Kim, Seoul (KR); Jin-Hee Jeong, Anyang-si (KR); Kum-ran Ji, Seoul (KR); Jong-hun Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/504,726

(22) Filed: Aug. 16, 2006

Related U.S. Application Data
(60) Provisional application No. 60/728,777, filed on Oct. 21, 2005.
(60) Provisional application No. 60/734,295, filed on Nov. 8, 2005.
(60) Provisional application No. 60/738,050, filed on Nov. 21, 2005.
(60) Provisional application No. 60/739,448, filed on Nov. 25, 2005.
(60) Provisional application No. 60/788,707, filed on Apr. 4, 2006.

(30) Foreign Application Priority Data
Jun. 20, 2006 (KR) 2006-68059

(51) Int. Cl. H04L 27/00; H04J 3/24

(52) U.S. Cl. 370/474; 375/295

(57) ABSTRACT

A dual transmission stream processing device includes an adaptor which receives a normal stream and generates an adaptation field in each packet of the normal stream; a stuffer which generates a dual transmission stream by stuffing a turbo stream into the adaptation field in a certain packet of the packets constructing the normal stream; and a supplementary reference signal stuffer which reconstructs the dual transmission stream such that a supplementary reference signal, the turbo stream, and the normal stream are combined by stuffing the supplementary reference signal into a first area which is part of the adaptation field of the packets constructing the normal stream. Accordingly, the channel status can be easily acquired as the turbo stream and the normal stream are transmitted effectively.

### CROSS-REFERENCE TO RELATED APPLICATIONS

This application claims priority from U.S. Provisional Application No. 60/728,777, filed on Oct. 21, 2005, U.S. Provisional Application No. 60/734,295, filed on Nov. 8, 2005, U.S. Provisional Application No. 60/738,050, filed on Nov. 21, 2005, U.S. Provisional Application No. 60/739,448, filed on Nov. 25, 2005, and U.S. Provisional Application No. 60/788,707 filed on Apr. 4, 2006, and of Korean Patent Application No. 2006-68059, filed on Jun. 20, 2006 in the Korean Intellectual Property Office, the entire disclosures of which are incorporated herein by reference.

### BACKGROUND OF THE INVENTION

1. Field of the Invention

Aspects of the present invention generally relate to a dual transmission stream processing device and method, which generate a dual transmission stream including a normal stream and a turbo stream for digital broadcasting. More particularly, aspects of the present invention relate to a dual transmission stream processing device and method for enhancing a digital broadcasting performance by generating a dual transmission stream including a normal stream and a robust-processed turbo stream so as to improve a reception performance of ATSC VSB system which is a terrestrial DTV system in the United States of America.

2. Description of the Related Art

A single-carrier ATSC VSB system, which is a terrestrial digital broadcasting system used in the U.S.A, uses a field sync per 312 segments. Hence, its reception performance is not good in a poor channel environment, especially, in a Doppler fading channel. FIG. 1 is a block diagram of a transmitter and a receiver, which are a general U.S.A. terrestrial digital broadcasting system, in conformity with the ATSC DTV standard. The digital broadcasting transmitter of FIG. 1 is the EVSB system suggested by Philips, and is constructed to generate and transmit a dual stream by adding a robust data to a normal stream of the conventional ATSC VSB system.

As shown in FIG. 1, the digital broadcasting transmitter executes error correction coding by including a randomizer 11 for randomizing the dual stream. A Reed-Solomon (RS) encoder 12 is a concatenated coder to add a parity byte to the transmission stream to correct an error occurring due to the channel characteristic during the transmission. An interleaver 13 interleaves the RS-encoded data in a certain pattern. A trellis encoder 14 maps to 8-level symbols by trellis-encoding the interleaved data at a ⅔ rate. A multiplexer 15 inserts field syncs and segment syncs to the data which passed through the error correction coding (as shown in FIG. 2). A modulator 16 inserts a pilot tone by adding a certain DC value to the data symbols having the inserted segment sync and field sync, performs the VSB modulation through the pulse shaping, up-converts to a RF channel band signal, and transmits the converted signal.

Accordingly, the digital broadcasting transmitter multiplexes (not shown) and applies the normal data and the robust data to the randomizer 11 according to the dual stream scheme which transmits the normal data and the robust data in one channel. The input data is randomized at the randomizer 11, and the randomized data is outer-coded at the RS encoder 12 which is an outer coder. The outer-coded data is interleaved at the interleaver 13. The interleaved data is inner-coded by 12 symbols at the trellis encoder 14 and mapped to 8-level symbols. The field sync and the segment sync are inserted to the mapped data. Next, the data is transmitted after inserting the pilot tone, performing the VSB modulation, and converting it to a RF signal.

A digital broadcasting receiver of FIG. 1, includes a tuner (not shown) for converting the RF signal, which is received through the channel, to a baseband signal, a demodulator 21 performs the sync detection and the demodulation on the converted baseband signal. An equalizer 22 compensates the channel distortion occurring due to the multipath with respect to the demodulated signal. A viterbi decoder 23 corrects an error of the equalized signal and decodes it to symbol data. A deinterleaver 24 deinterleaves the data which is interleaved by the interleaver 13 of the digital broadcasting transmitter. An RS decoder 25 corrects error. A derandomizer 26 derandomizes the data corrected at the RS decoder 25 and outputs a MPEG-2 transmission stream. Hence, the digital broadcasting receiver of FIG. 1 recovers the original signal in an inverse operation of the digital broadcasting transmitter by down-converting the RF signal to the baseband signal, demodulating and equalizing the converted signal, and carrying out the channel decoding.

FIG. 2 shows the VSB data frame having the inserted segment sync and field sync of the U.S.A. style digital broadcasting (8-VSB) system. As shown in FIG. 2, one frame consists of 2 fields. One field consists of a field sync segment, which is the first segment, and 312 data segments. In the VSB data frame, one segment corresponds to one MPEG-2 packet. One segment consists of 4-symbol segment sync and 828 data symbols. In FIG. 2, the segment sync and the field sync, which are the sync signals, are used for the synchronization and the equalization at the digital broadcasting receiver. In other words, the field sync and the segment sync are already known to the digital broadcasting transmitter and the digital broadcasting receiver and are used as a reference signal for the equalization of the digital broadcasting receiver.

The U.S.A. type terrestrial digital broadcasting system of FIG. 1 is constructed to generate and transmit the dual stream by adding the robust data to the normal data of the conventional ATSC VSB system so that the robust data can be transmitted together with the conventional normal data. However, the U.S.A. type terrestrial digital broadcasting system of FIG. 1 cannot enhance the poor reception performance of the conventional normal stream in the multipath channel, even when the dual stream is transmitted with the added robust data. Also, the reception performance of the turbo stream is not greatly enhanced in the multipath channel environment. Furthermore, the conventional digital broadcasting system is not able to check the channel status between the transmitter and the receiver. Therefore, a demand arises for a dual transmission stream generating method to facilitate the checking of the channel status and process the turbo stream more robustly at the same time.

### SUMMARY OF THE INVENTION

Aspects of the present invention provide a dual transmission stream processing device and/or a method to facilitate the checking of the channel status to the receiver and the robust processing of the turbo stream by generating and processing a dual transmission stream in which a supplementary reference signal, a normal stream, and a turbo stream are mixed.

According to an aspect of the present invention, a dual transmission stream processing device includes an adaptor which receives a normal stream and generates an adaptation field in each packet of the normal stream; a stuffer which generates a dual transmission stream by stuffing a turbo stream into the adaptation field in a certain packet of the packets constructing the normal stream; and a supplementary reference signal stuffer which reconstructs the dual transmission stream such that a supplementary reference signal, the turbo stream, and the normal stream are combined by stuffing the supplementary reference signal into a first area which is part of the adaptation field of the packets constructing the normal stream.

According to an aspect of the invention, the stuffer stuffs the turbo stream into a second area which is part of the adaptation field in the packets of the normal stream.

According to an aspect of the invention, the dual transmission stream includes at least one field which comprises a plurality of packets each containing the supplementary reference signal, turbo stream data, and normal stream data.

According to an aspect of the invention, the stuffer stuffs the turbo stream into areas other than the first area in the adaptation field, where the adaptation field is provided in the whole area of some of the normal stream packets.

According to an aspect of the invention, the dual transmission stream includes at least one first packet which contains the supplementary reference signal and the turbo stream data, and at least one second packet which contains the supplementary reference signal and the normal stream data, and the first packet and the second packet are arranged in an alternating manner according to an order.

According to an aspect of the invention, the stuffer stuffs the turbo stream into a third area which is a partial area not overlapping with the first area in the adaptation field which is provided in the whole area of some of the normal stream packets.

According to an aspect of the invention, the dual transmission stream includes at least one first packet which contains the supplementary reference signal, the turbo stream data, and the normal stream data, and at least one second packet which contains the supplementary reference signal and the normal stream data, and the first packet and the second packet are arranged in an alternating manner according to an order.

According to an aspect of the invention, the dual transmission stream includes at least one first packet which contains all of the supplementary reference signal, the turbo stream data, the normal stream data, at least one second packet which contains the supplementary reference signal and the normal stream data, and at least one third packet which contains the supplementary reference signal and the turbo stream data, and the first, second, third packets are arranged in an alternating manner according to an order.

According to an aspect of the invention, the dual transmission stream processing device further includes a Reed-Solomon (RS) encoder which receives and RS-encodes the turbo stream; an interleaver which interleaves the RS-encoded turbo stream; and a duplicator which generates a parity insertion area in the interleaved turbo stream and provides the turbo stream to the stuffer.

According to an aspect of the invention, the adaptor generates an option field for recording packet information, in a fixed packet of the normal stream packets.

According to an aspect of the invention, the option field contains at least one information of program clock reference (PCR), original program clock reference (OPCR), adaptation field extension length, transport private data length, and/or splice countdown.

According to an aspect of the present invention, a dual transmission stream processing method includes receiving a normal stream and generating an adaptation field in each packet of the normal stream; generating a dual transmission stream by stuffing a turbo stream into the adaptation field in a certain packet of the packets constructing the normal stream; and reconstructing the dual transmission stream such that a supplementary reference signal, the turbo stream, and the normal stream are combined by stuffing the supplementary reference signal into a first area which is part of the adaptation field of the packets constructing the normal stream.

According to an aspect of the invention, the generating the dual transmission stream comprises stuffing the turbo stream into a second area which is part of the adaptation field in the packets of the normal stream.

According to an aspect of the invention, the dual transmission stream includes at least one field which comprises a plurality of packets, each packet containing the supplementary reference signal, turbo stream data, and normal stream data.

According to an aspect of the invention, the generating the dual transmission stream comprises stuffing the turbo stream into areas other than the first area in the adaptation field which is provided in the whole area of some of the normal stream packets.

According to an aspect of the invention, the dual transmission stream includes at least one first packet which contains the supplementary reference signal and the turbo stream data, and at least one second packet which contains the supplementary reference signal and the normal stream data, and the first packet and the second packet are arranged in an alternating manner according to an order.

According to an aspect of the invention, the generating the dual transmission stream comprises stuffing the turbo stream into a third area, which is a partial area not overlapping with the first area in the adaptation field, which is provided in the whole area of some of the normal stream packets.

According to an aspect of the invention, the dual transmission stream includes at least one first packet which contains the supplementary reference signal, the turbo stream data, and the normal stream data, and at least one second packet which contains the supplementary reference signal and the normal stream data, and the first packet and the second packet are arranged in an alternating manner according to an order.

According to an aspect of the invention, the dual transmission stream includes at least one first packet which contains the supplementary reference signal, the turbo stream data, and the normal stream data, at least one second packet which contains the supplementary reference signal and the normal stream data, and at least one third packet which contains the supplementary reference signal and the turbo stream data, and the first, second, third packets are arranged in an alternating manner according to an order.

According to an aspect of the invention, the dual transmission stream processing method further includes receiving the turbo stream and performing a Reed-Solomon (RS) encoding; interleaving the RS-encoded turbo stream; and generating a parity insertion area in the interleaved turbo stream and applying the turbo stream to the receiving the normal stream.

According to an aspect of the invention, the receiving the normal stream generates an option field for recording packet information, in a fixed packet of the normal stream packets.

According to an aspect of the invention, the option field contains at least one information of program clock reference (PCR), original program clock reference (OPCR), adaptation field extension length, transport private data length, and/or splice countdown.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional digital broadcasting (ATSC VSB) transmission and reception system;

FIG. 2 is a diagram of a conventional ATSC VSB data frame format;

FIG. 3 is a block diagram of a dual transmission stream processing device according to an embodiment of the present invention;

FIG. 4 is a conceptual diagram of a normal stream format received to the dual transmission stream processing device of FIG. 3 according to an aspect of the invention;

FIG. 5 is a conceptual diagram of a normal stream format having an adaptation field according to an aspect of the invention;

FIGS. 6 through 10 are conceptual diagrams of various exemplary formats of the dual transmission stream which is generated at the dual transmission stream processing device according to embodiments of the present invention; and

FIG. 11 is a detailed block diagram of the dual transmission stream processing device of FIG. 3 according to an aspect of the invention.

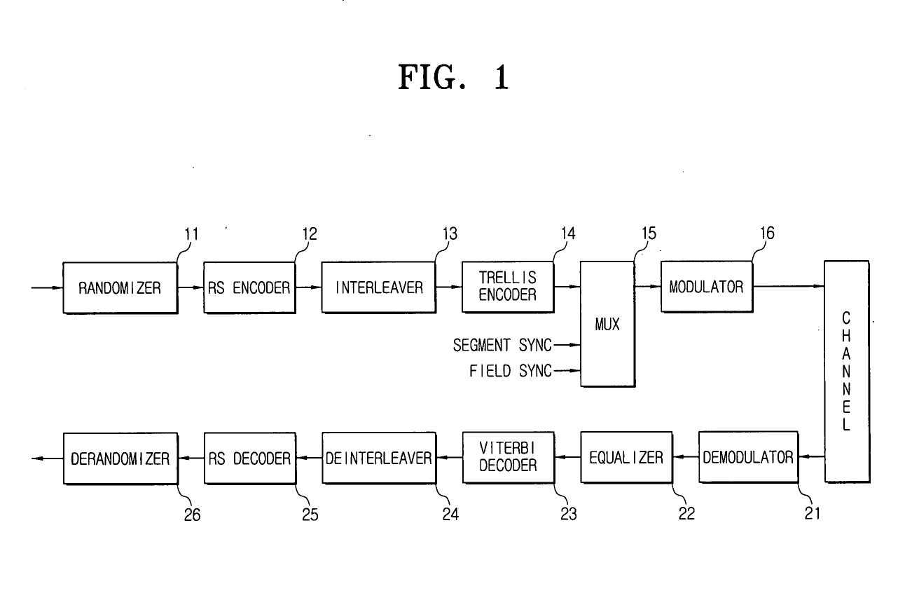

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 3 is a block diagram of a dual transmission stream processing device according to an embodiment of the present invention. The dual transmission stream processing device of FIG. 3 includes an adaptor 110, a stuffer 120, and a supplementary reference signal stuffer 130. The adaptor 110 receives a normal stream and generates an adaptation field in the normal stream. The adaptation field is an area for inserting various data, such as supplementary reference signal or other like training data, turbo stream data and so on. In more detail, the adaptor 110 can generate the adaptation field in part or all of areas of packets making up the normal stream.

The stuffer 120 generates a dual transmission stream by inserting a turbo stream into the adaptation field of the normal stream. The dual transmission stream is the combination of the turbo stream and the normal stream. The turbo stream is a data stream which is compressed according to a certain compression standard and robustly processed through a turbo coding process. The normal stream and the turbo stream can be received, by way of example, from an external module such as camera for broadcasting according to an aspect of the invention. In addition to or instead of the external module, the streams can also be received from various internal modules, such as compression processing module (e.g., MPEG-2 module) video encoder, and audio encoder according to aspects of the invention.

One frame of the dual transmission stream generated at the stuffer 120 includes at least one field. Each field consists of a plurality of packets. Each packet has the adaptation field. The turbo stream (i.e., the turbo data) can be inserted into the adaptation field in some or all of the packets according to embodiments of the invention. However, it is understood that other fields of the packet can be defined and/or used for the turbo data in other aspects of the invention.

The supplementary reference signal stuffer 130 inserts a supplementary reference signal to an area (hereinafter, referred to as a first area) of the adaptation field, which is generated to in each packet of the normal stream. The supplementary reference signal is a signal pattern known to both of the transmitter and the receiver. The broadcasting receiver can easily check the channel status by comparing the supplementary reference signal of the received stream with the known supplementary reference signal. The checked channel status is usable for determining a signal compensation degree. While described as a supplementary reference signal, it is understood that any similar training sequence can be used instead of or in addition to the supplementary reference signal.

Although it is not illustrated in FIG. 3, the dual transmission stream processing device may further include a randomizer (not shown). The randomizer may be located in front of the supplementary reference signal stuffer 130 according to an aspect of the invention.

FIG. 4 is a conceptual diagram of a normal stream format received at the dual transmission stream processing device. Referring to FIG. 4, a packet of the normal stream includes a sync, a header, and normal data. While not required in all aspects, the header may contain a transport error indicator, a payload start indicator, a transport priority, a packet identifier (PID), so forth. It is understood that the normal stream can be otherwise formatted.

According to an aspect of the invention, the whole normal stream packet of FIG. 4 consists of 188 bytes. Of the 188 bytes, 1 byte is assigned for the sync, 3 bytes are assigned for the header, and the 184 bytes are assigned for the payload (i.e., the normal data recording area). The dual transmission stream processing device of aspects of the present invention can provide an area for the turbo stream insertion by receiving the normal stream as shown in FIG. 4 and generating the adaptation field in the normal stream.

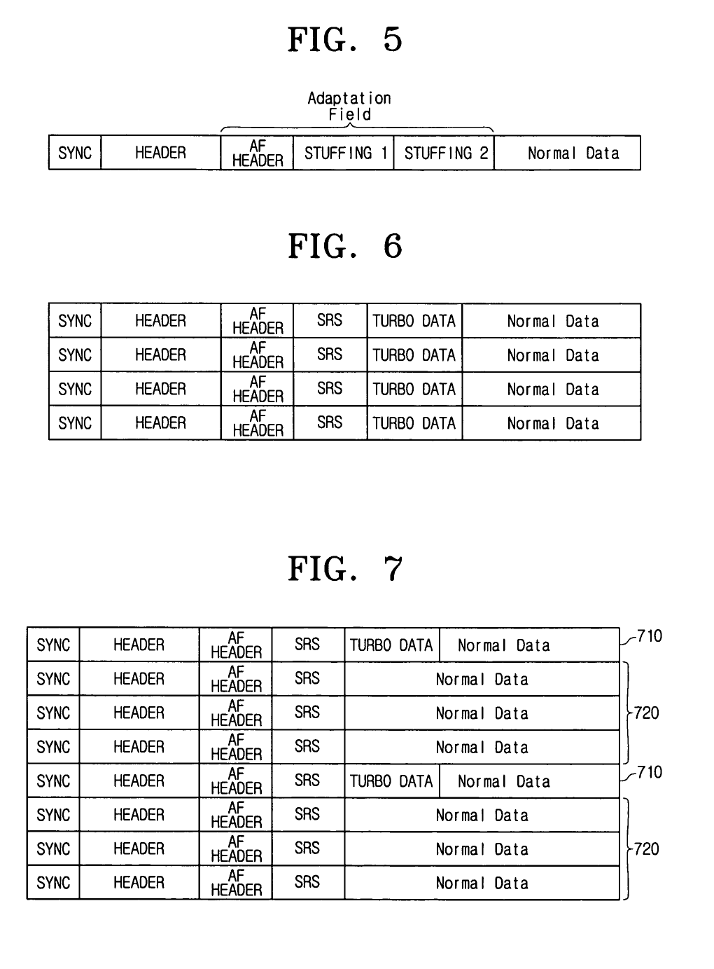

FIG. 5 is a conceptual diagram of a normal stream format having an adaptation field according to an aspect of the invention. Referring to FIG. 5, the normal stream includes a sync, a header, an adaptation field, and a normal data area. The adaptation field includes an adaptation field (AF) header and a stuffing area. As shown in FIG. 5, the stuffing area is divided into a first stuffing area and a second stuffing area, but may be further divided according to a quantity of data to be stuffed.

According to an aspect of the invention, the AF header is an area for recording information relating to location and size of the adaptation field. The AF header may consist of 2 bytes. The size of the stuffing area can be determined adaptively, depending on the quantity of data to be stuffed to the adaptation field. For instance, assuming that the size of the first stuffing area is S bytes and that of the second stuffing area is N bytes, S+N may be one value between 0 through 182. In other words, the areas other than the areas for the sync, the header and the AF header can be used as the stuffing area. However, it is understood that the AF header need not be used in all aspects, such as where the information on the adaptation field is otherwise located within the packet, in another location, or is defined in a standard with which the transmitter and receiver are compliant.

When the adaptation field is generated, the normal data area is reduced by S+N. Specifically, if the whole payload area is 184 bytes, the normal data area is 184−S−N bytes. While not required, a control area for controlling the adaptation field may be added to the header according to the generation of the adaptation field.

The stuffer 120 generates the dual transmission stream by inserting the turbo stream into the adaptation field of FIG. 5. Still referring to FIG. 5, the turbo stream is stuffed into the second stuffing area. Although FIG. 5 illustrates that the adaptation field is generated only in part of the payload area, the adaptation field may occupy the whole payload area. Referring to FIG. 5, the supplementary reference signal stuffer 130 stuffs the supplementary reference signal into the first stuffing area. However, it is understood that the stuffers 120 and 130 can be combined in other aspects of the invention.

FIG. 6 is a conceptual diagram of an exemplary format of the dual transmission stream generated at the dual transmission stream processing device according to an aspect of the invention. Referring to FIG. 6, the dual transmission stream is constructed with a plurality of packets being connected in series. Each packet includes all of the supplementary reference signal, the turbo stream and the normal stream. The stuffer 120 stuffs the turbo stream into a certain area (hereafter, referred to as a second area) of the adaptation field which is generated in every normal stream packet. Note that the first area and the second area do not overlap with each other. Accordingly, the dual transmission stream is generated as illustrated in FIG. 6. As shown in FIG. 6, the packet includes the sync, the header, the AF header, the supplementary reference signal (SRS), the turbo stream data, and the normal stream data.

FIG. 7 is a conceptual diagram of another exemplary format of the dual transmission stream generated at the dual transmission stream processing device. The stuffer 120 can generate the dual transmission stream by inserting the turbo stream data only into an area, which does not overlap with the first area, of the adaptation field of some of the normal stream packets 710. Others of the packets 720 do not include the turbo stream data, and instead include normal data of the normal stream in the second stuffing area. After the supplementary reference signal stuffer 130 inserts the supplementary reference signal into the generated dual transmission stream as aforementioned, the dual transmission stream is completed as shown in FIG. 7.

In FIG. 7, some packets 710 of the dual transmission stream include all of the SRS, the turbo stream data, and the normal stream data. The stuffer 120 generates the dual transmission stream, as shown in FIG. 7, by inserting the turbo stream data to an area (hereafter, referred to as a third area), which does not overlap with the first area, in the adaptation field of some 710 of the whole normal stream packets. Other packets 720 are constructed to include merely the SRS and the normal stream.

To ease the understanding, the packets 710 are referred to as first packets, and the packets 720 are referred to as second packets. The first packets 710 and the second packets 720 can be arranged in an alternating manner according to a specific order. While not restricted thereto, the first packets 710 may be followed by one or more of the second packets 720, and vice versa. In the example in FIG. 7, the first packets 710 are followed by three second packets 720.

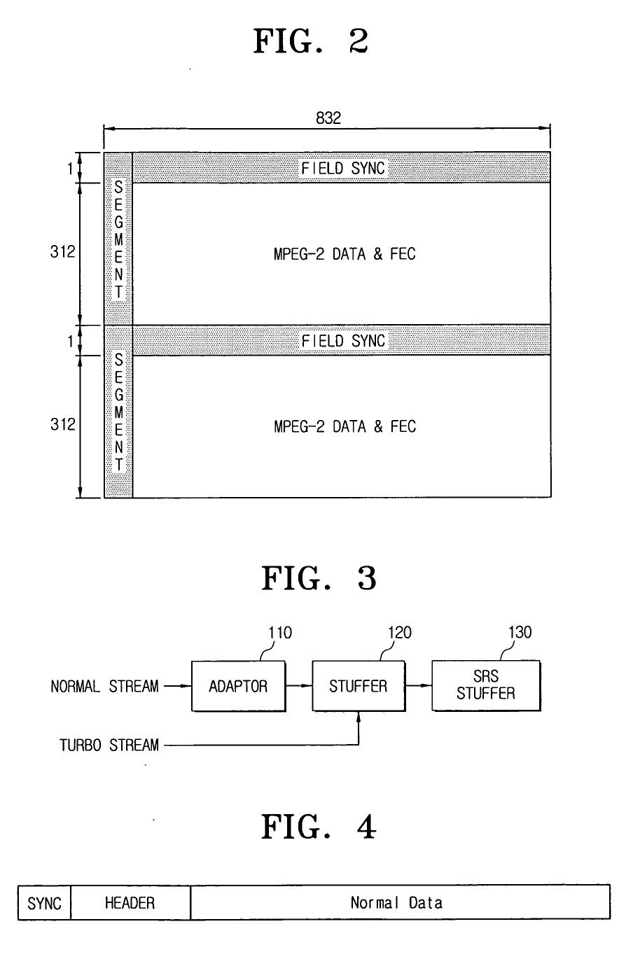

In FIG. 7, assuming one field of the dual transmission stream consists of 312 packets consistent with the VSB data frame of FIG. 2, the number of the first packets 710 is 78 in total. In case that 70 first packets 710 are inserted into 312 packets of the dual transmission stream, the dual transmission packet is constructed such that first packets and the second packets are repeated in the ratio of 1:3 in groups of 4 packets for 70 times. The remaining 32 packets consist of merely the second packets 720 alone. However, it is understood that other ratios can be used, and that the remaining 32 packets can be of the first packets 710 and/or the second packets 720 in other ratios.

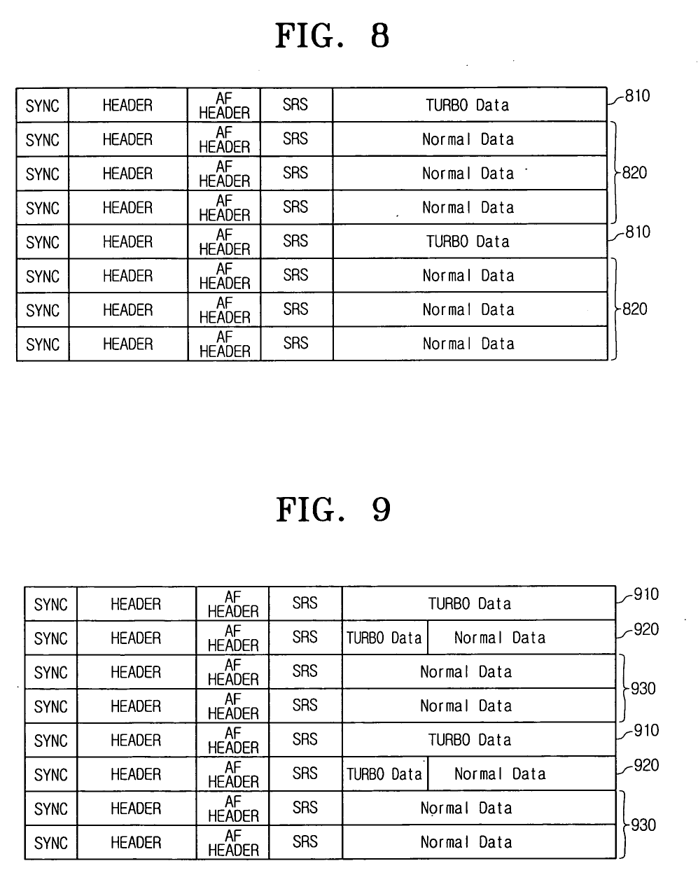

FIG. 8 is a conceptual diagram of still another example of the dual transmission stream format generated at the dual transmission stream processing device. In FIG. 8, some packets 810 of the dual transmission stream are constructed with the SRS and the turbo stream data. Other packets 820 are constructed with the SRS and the normal stream data. To ease the understanding, the packets 810 are referred to as first packets, and the other packets 820 are referred to as second packets.

While not required in all aspects, the first packets 810 and the second packets 820 of FIG. 8 can be arranged in an alternating manner according to a specific order. Although the first and second packets 810, 820 are arranged in the ratio of 1:3 in FIG. 8, it is understood that other ratios can be used (i.e., they can be arranged in the ratio of n:m, where n and m are natural numbers). For instance, the turbo stream packet 810 and the normal stream packet 820 can be arranged in various ratios of 1:4, 2:2, 2:3 and so on.

FIG. 9 is a conceptual diagram of yet another example of the dual transmission stream format generated at the dual transmission stream processing device. Referring to FIG. 9, the dual transmission stream can be constructed with a first packet 910, a second packet 920, and a third packet 930. The first packet 910 includes the SRS and the turbo stream data, but does not include normal data. The second packet 920 includes the SRS, the turbo stream data, and the normal stream data. The third packet includes the SRS and the normal stream data, but does not include the turbo data.

The first, second and third packets 910, 920, 930 are arranged in an alternating manner according to a specific order. For instance, in one order, the first, second and third packets 910, 920, 930 are sequentially arranged. In another example, the first, third and second packets 910, 930, 920 are sequentially arranged. In another example, the third, second and first packets 930, 920, 910 are sequentially arranged.

In addition, the first, second and third packets 910, 920, 930 may be arranged in the ratio of n:m:x (n, m and x are natural numbers). In FIG. 9, the first, second and third packets 910, 920, 930 are arranged in the ratio of 1:1:2. However, other ratios are possible and the ratios can be even (i.e., n=m=x) in other aspects of the invention.

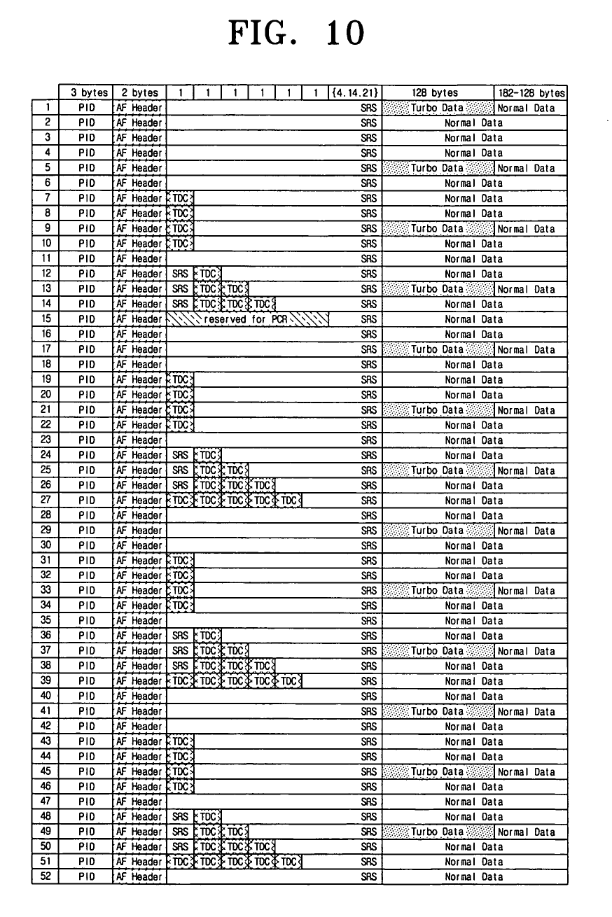

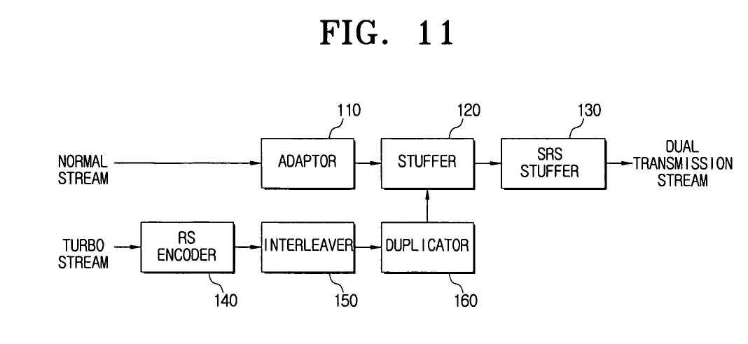

FIG. 10 is a conceptual diagram of the expanded dual transmission stream of FIG. 7 for a set of 52 packets. Referring to FIG. 10, the packets 710 containing both the turbo stream and the normal stream, and the packets 720 containing only the normal stream are arranged in the alternating manner. The SRS is inserted into every packet of the 52 packet set shown.

In FIG. 10, certain ones of the packets include the tunneling data channel (TDC). The TDC is an empty area for a user's other necessary purposes. The TDC can occupy 6 bytes of the stuffing area at a maximum in the shown embodiment, but can have other sizes and frequencies. The TDC may be located at the front end of the stuffing area containing the SRS, or between the SRS data. It is understood that the TDC need not be used in all aspects of the invention, and/or can be located in other locations.

Additionally and while not required in all aspects, an option field provided in some packets of the dual transmission stream. The option field is an area for containing diverse information relating to the packet. The location of the option field may be fixed to not overlap with the turbo stream in aspects of the invention. Referring back to FIG. 10, by way of example of the option field, a program clock reference (PCR) is fixed to the 15^{th} packet. The packet information recorded in the option field can be at least one of PCR, original program clock reference (OPCR), adaptation field extension length, transport private data length, and splice countdown.

The location of the option field containing the packet information may be fixed not to overlap with the area of the turbo stream. By way of a non limiting example, when 312 segments are divided by 52 segments, the location of the option field is expressed as follows:

PCR (occupy 6 bytes): 52n+15, n=0

OPCR (occupy 6 bytes): 52n+15, n=1

adaptation field extension length (occupy 2 bytes): 52n+15, n=2

transport private data length (occupy 5 bytes): 52n+15, n=3, 4, 5

splice countdown (occupy 1 byte): 52n+15, n=0, 1, 2, 3, 4, 5

Although it is not illustrated in FIG. 10, the transport private data length is located at the 171st, 223rd, and 275th packets in accordance with the above expressions.

In addition to the formats as shown in FIGS. 6 through 10, the dual transmission stream packet can be variously constructed by inserting the turbo stream into null data excluding the option field of the adaptation field. The ratio of the turbo stream is adjustable depending on the format of the dual transmission stream packet.

FIG. 11 is a detailed block diagram of the dual transmission stream processing device of FIG. 3 according to an aspect of the invention. Referring to FIG. 11, the dual transmission stream processing device includes an adaptor 110, a stuffer 120, a supplementary reference signal stuffer 130, a RS encoder 140, an interleaver 150, and a duplicator 160. The adaptor 110 and the stuffer 120 may be a multiplexer since the adaptor 110 and stuffer 120 serve to arrange the normal stream and the turbo stream in the single transmission stream, but need not in all aspects of the invention.

The RS encoder 140 RS-encodes the turbo stream which is received from an outside source. More specifically, the RS encoder 140 receives the turbo stream including the sync, the header, and the turbo data. While not required in all aspects, the whole turbo stream packet may consist of 188 bytes.

Specifically, the packet can include 1-byte sync, 3-byte header, and 184-byte turbo data. The RS encoder 140 removes the sync from the turbo stream and appends a 20-byte parity by calculating the parity for the turbo data area. Consequently, a packet of the finally encoded turbo stream consists of 207 bytes in total. Of the 207 bytes, 3 bytes are assigned to the header, 184 bytes are assigned to the turbo data, and 20 bytes are assigned to the parity. However, it is understood that other byte sizes can be assigned for the parity, header and/or turbo data in the packets in other aspects of the invention.

The interleaver 150 interleaves the RS-encoded turbo stream and provides the interleaved stream to the duplicator 160. The duplicator 160 generates a parity insertion area to insert the parity into the turbo stream and applies the turbo stream to the stuffer 120. The stuffer 120 receives the normal stream including the adaptation field generated at the adaptor 110, and generates the dual transmission stream by stuffing the adaptation field with the turbo stream provided from the duplicator 160. The supplementary reference signal stuffer 130 stuffs the supplementary reference signal into the stuffing area of the dual transmission stream generated at the stuffer 120 and reconstructs the dual transmission stream such that the supplementary reference signal, the turbo stream data, and the normal stream data are combined in the dual transmission stream.

Further detailed descriptions are made on how the duplicator 160 generates the parity insertion area according to an aspect of the invention. First, the duplicator 160 divides the bytes, which are the constituent units of the turbo stream, by 2 or 4 bytes. Each byte is stuffed with some of the bit values of the original byte, and null data (e.g., 0). The null data area becomes the parity insertion area. However, it is understood that the bytes can be divided by numbers other than 2 or 4.

More detailed illustration is provided by way of example. For instance, if the input is doubled in size, and bits in one byte are a, b, c, d, e, f, g, h from the MSB, the output of the duplicator 160 can be represented as a, a, b, b, c, c, d, d, e, e, f, f, g, g, h, h. In this case, it is noted that 2 bytes including 1 byte of a, a, b, b, c, c, d, d and 1 byte of e, e, f, f, g, g, h, h are output in sequence from the MSB. In case that the input is quadrupled in size, the output of the duplicator 160 can be expressed as a, a, a, a, b, b, b, b, c, c, c, c, d, d, d, d, e, e, e, e, f, f, f, f, g, g, g, g, h, h, h, h. As such, 4 bytes are produced.

The duplicator 160 may stuff positions other than the designated positions with random values (that is, with null data) without having to duplicate the input bits. For instance, when the duplicator 160 doubles the input, in two successive bits, the former bit sustains its original input and the latter bit is stuffed with a random value like a, x, b, x, c, x, . . . rather than a, a, b, b, c, c, . . . or vice versa. When the input is quadrupled, the original input may be positioned to one of first, second, third, and fourth positions and the other positions may be stuffed with random values.

The dual transmission stream generated by the dual transmission stream processing device of an aspect of the present invention is transmitted to the receiver after passing through the encoding, the robust processing, the sync multiplexing, and the modulation. The robust processing detects only the turbo stream from the dual transmission stream and makes the turbo stream into the robust data stream by appending the parity for the turbo stream into the parity insertion area of the detected turbo stream. That is, the parity is appended into the parity insertion area generated by the duplicator 160. Since the construction to process and transmit the generated dual transmission stream can be implemented with various schemes well known in the art (such as through the air, cable, internet, satellite and while recorded on a medium for long term storage, or in a buffer during the transmission process for short term storage), further explanation will be omitted for brevity.

A dual transmission stream generating method according to an embodiment of the present invention, receives the normal stream and generates the adaptation field in the normal stream. The position and the size of the generated adaptation field depend on the quantity of the turbo stream. More specifically, the adaptation field may occupy part or all of the payload area. Next, the dual transmission stream is generated by stuffing the adaptation field with the turbo stream which is received separately. With respect to the turbo stream, the RS encoding and the interleaving are executed, the parity insertion area is provided, and then the adaptation field is inserted.

When the dual transmission stream is generated, the dual transmission stream is reconstructed by inserting the supplementary reference signal to some adaptation fields of the stream. Thus, the dual transmission stream can be produced in various formats, non limiting examples of which are shown in FIGS. 7 through 10. Since one can easily understand the dual transmission stream generating method of aspects of the present invention in reference to FIGS. 3 through 11, any flowcharts outlining the dual transmission stream generating method will be omitted. Additionally, while not required in all aspects, aspects of the invention can be implemented as computer readable code encoded on one or more computer readable media for use on one or more processors and/or computers.

As set forth above and while not limited thereto, the dual transmission stream including the normal stream and the turbo stream can be generated to enhance the reception performance of the ATSC VSB system, which is the terrestrial DTV system used in the U.S.A. In this case, it is possible to efficiently transmit the turbo stream and the normal stream by adjusting the format of the dual transmission stream. Additionally, since the supplementary reference signal is inserted to the dual transmission stream and transmitted together, the reception side can easily acquire the channel status.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A dual transmission stream processing device comprising:
an adaptor which receives a normal stream and generates an adaptation field in each packet of the normal stream;
a stuffer which generates a dual transmission stream by stuffing a turbo stream into the adaptation field in at least one of the packets of the normal stream; and
a supplementary reference signal stuffer which re-constructs the dual transmission stream by combining a supplementary reference signal, the turbo stream, and the normal stream are combined by stuffing the supplementary reference signal into a first area of the adaptation field of the packets.

2. The dual transmission stream processing device of claim 1, wherein the stuffer stuffs the turbo stream into a second area of the adaptation field in the at least one of the packets.

3. The dual transmission stream processing device of claim 2, wherein:
the dual transmission stream includes at least one field which comprises a plurality of packets, and
each packet has the supplementary reference signal, turbo stream data, and normal stream data.

4. The dual transmission stream processing device of claim 1, wherein:
the stuffer stuffs the turbo stream into an area other than the first area in the adaptation field, and
the area is provided in the whole area of some of the normal stream packets having the first areas.

5. The dual transmission stream processing device of claim 4, wherein:
the dual transmission stream includes:
at least one first packet which contains the supplementary reference signal and the turbo stream data, and
at least one second packet which contains the supplementary reference signal and the normal stream data, and
the first packet and the second packet are arranged in an alternating manner according to an order.

6. The dual transmission stream processing device of claim 1, wherein the stuffer stuffs the turbo stream into a third area which is a partial area not overlapping the first area in the adaptation field and which is provided in the whole area of some of the normal stream packets.

7. The dual transmission stream processing device of claim 6, wherein:
the dual transmission stream includes:
at least one first packet which contains the supplementary reference signal, the turbo stream data, and the normal stream data, and
at least one second packet which contains the supplementary reference signal and the normal stream data, and
the first packet and the second packet are arranged in an alternating manner according to an order.

8. The dual transmission stream processing device of claim 1, wherein
the dual transmission stream includes
at least one first packet which contains the supplementary reference signal, the turbo stream data, and the normal stream data,
at least one second packet which contains the supplementary reference signal and the normal stream data, and
at least one third packet which contains the supplementary reference signal and the turbo stream data, and
the first, second, third packets are arranged in an alternating manner according to an order.

9. The dual transmission stream processing device of claim 1, further comprising:
a Reed-Solomon (RS) encoder which receives and RS-encodes the turbo stream;
an interleaver which interleaves the RS-encoded turbo stream; and
a duplicator which generates a parity insertion area in the interleaved turbo stream and provides the interleaved turbo stream to the stuffer.

10. The dual transmission stream processing device of claim 1, wherein the adaptor generates an option field for recording packet information, in a predetermined one of the packets of the normal stream packets.

11. The dual transmission stream processing device of claim 10, wherein the option field contains at least one information of program clock reference (PCR), original program clock reference (OPCR), adaptation field extension length, transport private data length, and/or splice countdown.

12. A dual transmission stream processing method comprising:
receiving a normal stream and generating an adaptation field in each packet of the normal stream;
generating a dual transmission stream by stuffing a turbo stream into the generated adaptation field in a one or more of the packets constructing the normal stream; and
reconstructing the generated dual transmission stream such that a supplementary reference signal, the turbo stream, and the normal stream are combined by stuffing the supplementary reference signal into a first area of the generated adaptation field of the packets constructing the normal stream.

13. The dual transmission stream processing method of claim 12, wherein the generating the dual transmission stream comprises stuffing the turbo stream into a second area which is part of the adaptation field in the packets of the normal stream.

14. The dual transmission stream processing method of claim 13, wherein the dual transmission stream includes at least one field which comprises a plurality of packets, each packet containing the supplementary reference signal, turbo stream data, and normal stream data.

15. The dual transmission stream processing method of claim 12, wherein the generating the dual transmission stream comprises stuffing the turbo stream into areas other than the first area in the adaptation field and which is provided in the whole area of some of the normal stream packets.

16. The dual transmission stream processing method of claim 15, wherein:
the dual transmission stream includes:
at least one first packet including the supplementary reference signal and the turbo stream data, and
at least one second packet including the supplementary reference signal and the normal stream data, and
the first packet and the second packet are arranged in an alternating manner according to an order.

17. The dual transmission stream processing method of claim 12, wherein the generating the dual transmission stream comprises stuffing the turbo stream into a third area which is a partial area not overlapping the first area in the adaptation field which is provided in the whole area of some of the normal stream packets.

18. The dual transmission stream processing method of claim 17, wherein:
the dual transmission stream includes:
at least one first packet including all of the supplementary reference signal, the turbo stream data, and the normal stream data, and
at least one second packet including the supplementary reference signal and the normal stream data, and
the first packet and the second packet are arranged in an alternating manner according to an order.

19. The dual transmission stream processing method of claim 12, wherein:
the dual transmission stream includes:
at least one first packet including the supplementary reference signal, the turbo stream data, and the normal stream data,
at least one second packet including the supplementary reference signal and the normal stream data, and
at least one third packet including the supplementary reference signal and the turbo stream data, and
the first, second, third packets are arranged in an alternating manner according to an order.

20. The dual transmission stream processing method of claim 12, further comprising:
receiving the turbo stream and performing Reed-Solomon (RS) encoding;
interleaving the RS-encoded turbo stream; and
generating a parity insertion area in the interleaved turbo stream and applying the turbo stream to the generating the normal stream with the adaptation field.

21. The dual transmission stream processing method of claim 12, wherein the generating the normal stream with the adaptation field includes generating an option field for recording packet information, in a predetermined packet of the normal stream packets.

22. The dual transmission stream processing method of claim 21, wherein the option field contains information of program clock reference (PCR), original program clock reference (OPCR), adaptation field extension length, transport private data length, and/or splice countdown.

23. A dual transmission stream processing device comprising:
an adaptor which receives a normal stream of normal data and generates an adaptation field in each packet of the normal stream; and
a stuffer which generates a dual transmission stream by stuffing a turbo data of a turbo stream into a first portion of the adaptation field in at least one of the packets, and a training sequence into a second portion of the adaptation field other than the first portion of all of the packets including the one packet, wherein the training sequence is compared with a training sequence at a receiving device to check a channel status.

24. The dual transmission stream processing device of claim 23, wherein the training sequence comprises a supplementary reference signal.

25. The dual transmission stream processing device of claim 23, wherein:
each packet of the normal stream, prior to the adaptor, comprises a sync, a header, and the normal data, and
the adaptor generates the adaptation field in the normal data of each packet.

26. The dual transmission stream processing device of claim 23, wherein the stuffer stuffs each packet of the normal stream such that each packet includes the turbo data in the first portion and the normal data in a third portion outside of the adaptation field.

27. The dual transmission stream processing device of claim 23, wherein the stuffer stuffs each packet of the normal stream such that:
a first packet includes the turbo data in the first portion and the normal data in a third portion outside of the adaptation field, and
a second packet includes the normal data in the first portion and the third portion.

28. The dual transmission stream processing device of claim 23, wherein the stuffer stuffs each packet of the normal stream such that:
a first packet includes the turbo data in the first portion and no normal data in a third portion outside of the adaptation field, and
a second packet includes the normal data in the first portion and the third portion.

29. The dual transmission stream processing device of claim 23, wherein the stuffer stuffs each packet of the normal stream such that:
a first packet includes the turbo data in the first portion and normal data in a third portion outside of the adaptation field,
a second packet includes the normal data in the first portion and the third portion, and
a third packet includes the turbo data in the first portion and no normal data in the third portion.

30. The dual transmission stream processing device of claim 23, wherein:
the stuffer stuffs each packet of the normal stream such that each packet includes an adaptation field header in a third portion of the adaptation field, and
the adaptation field header includes information on a size and/or location of the adaptation field.

31. A medium encoded with a normal stream and a turbo stream multiplexed and disposed in packets of a dual transport stream decodable by a receiver, one of the packets comprising:
a header including information used by the receiver to detect information on the packet;
an adaptation field having a first portion including a training sequence used by the receiver to detect a status of a channel through which the packet is transmitted, and a second portion other than the first portion including turbo encoded data detected and decoded by the receiver to remove and decode turbo encoded data of the turbo stream; and
a normal data field detected and decoded by the receiver to remove and decode the normal data of the normal stream.

32. The medium of claim 31, wherein:
each of the packets includes the training sequence in the first portion, and
the training sequence comprises a supplementary reference signal.

33. The medium of claim 31, wherein:
each packet of the normal stream prior to being multiplexed comprises a sync, a header, and a normal data area storing the normal data, and
the adaptation field is in the normal data area of each packet.

34. The medium of claim 31, wherein each packet includes the turbo data in the second portion.

35. The medium of claim 31, wherein another one of the packets includes the normal data in the second portion and does not include the turbo data.

36. The medium of claim 31, wherein another one of the packets includes the turbo data in the second portion and the normal data field such that no normal data is in the another packet.

37. The medium of claim 31, wherein:
the packet includes an adaptation field header in a third portion of the adaptation field, and
the adaptation field header includes information used by the receiver to determine a size and/or location of the adaptation field.
